(19) United States
(12) Patent Application Publication
(10) Pub. No.: US 2025/0122025 A1
(43) Pub. Date: Apr. 17, 2025

(54) OVERHEAD CONVEYOR APPARATUS, OVERHEAD CONVEYOR FACILITY COMPRISING SUCH AN OVERHEAD CONVEYOR APPARATUS AND CONVEYING METHOD FOR GOODS

(71) Applicant: Dürkopp Fördertechnik GmbH, Bielefeld (DE)

(72) Inventors: Frank LANDERMANN, Leopoldshöhe (DE); Markus MERTEN, Bielefeld (DE)

(21) Appl. No.: 18/907,752

(22) Filed: Oct. 7, 2024

(30) Foreign Application Priority Data
Oct. 12, 2023 (DE) 10 2023 210 022.3

(51) Int. Cl. B65G 47/26; B65G 19/02

(52) U.S. Cl. CPC B65G 47/265; B65G 19/025; B65G 47/266; B65G 2203/0291

(57) ABSTRACT

An overhead conveyor apparatus includes a conveyor rail defining a conveying direction. A plurality of overhead adapters are movable via the conveyor rail in the conveying direction. A stopping member is arranged on the conveyor rail for stopping at least one overhead adapter of the plurality of overhead adapters. A holding unit is arranged upstream of the stopping member for holding at least one overhead adapter of the plurality of overhead adapters.

### CROSS-REFERENCES TO RELATED APPLICATIONS

This application claims the priority of German Patent Application, Serial No. DE 10 2023 210 022.3, filed Oct. 12, 2023, the content of which is incorporated herein by reference in its entirety as if fully set forth herein.

### FIELD

The invention relates to an overhead conveyor apparatus, an overhead conveyor facility comprising such an overhead conveyor apparatus and a method for conveying goods.

### BACKGROUND

An overhead conveyor apparatus is known from DE 10 2010 010 107 A1. The overhead conveyor apparatus is used to convey overhead adapters along a conveyor rail. Conveyor bags loaded with goods can hang from the overhead adapters. It may be necessary to stop the overhead adapters along the overhead conveyor apparatus, for example due to a subsequent separation process or a discharge process. Due to the fact that an overhead adapter is stopped in the conveyor rail, subsequent overhead adapters in the conveyor rail move onto it and are also stopped as a result. With each additional overhead adapter that is accumulated, the dynamic pressure on the overhead adapters arranged upstream increases. There is a risk that the leading overhead adapters, in particular the foremost one, will be damaged and/or destroyed. The loaded conveyor bags have a bag thickness along the conveying direction that is generally greater than the width of the overhead adapter oriented in the conveying direction. As a result of the bag thickness, the leading loaded conveyor bags are pushed forwards and swiveled upwards during accumulation. There is a risk that the swiveled bags will slide sideways and break out of the row. Continuation of conveying after opening the stopping member may be impaired or prevented.

To avoid excessive dynamic pressure, it is known to regularly arrange stopping members along the conveyor rail in order to limit the maximum number of bags to be accumulated and thus the dynamic pressure. This type of facility is disadvantageous because storage space in the overhead conveyor apparatus remains unused. In addition, the investment in the facility is increased due to the increased number of stopping members.

### SUMMARY

It is an object of the present disclosure to enable the accumulation of suspended conveyed goods in an uncomplicated and reliable manner, in particular without collisions.

This object is achieved by an overhead conveyor apparatus comprising a conveyor rail defining a conveying direction, a plurality of overhead adapters movable in the conveyor rail in the conveying direction, a stopping member arranged on the conveyor rail, for stopping the overhead adapters in the conveyor rail, a holding unit arranged upstream of the stopping member, for holding at least one overhead adapter arranged in the region of the holding unit, by an overhead conveyor facility comprising at least one said overhead conveyor apparatus and by a method comprising the method steps of overhead conveying of goods in conveyor bags by means of overhead adapters in a conveyor rail defining a conveying direction, stopping the overhead adapters in the conveyor rail by means of a stopping member arranged on the conveyor rail and holding overhead adapters arranged upstream of the stopping member by means of the holding unit.

A holding unit is arranged upstream of a stopping member in an overhead conveyor apparatus, with which at least one overhead adapter is held in the region of the holding unit. In particular, multiple overhead adapters are held simultaneously by the holding unit, in particular at least three overhead adapters, in particular at least five, in particular at least seven, in particular at least eight and in particular at least ten. In particular, at most fifty overhead adapters are held by the holding unit. In particular, it is avoided that only one, in particular a single, overhead adapter is held, onto which subsequent overhead adapters run. With the overhead conveyor apparatus, the dynamic pressure on the individual overhead adapters, in particular the overhead adapters arranged at the front in the conveying direction, is reduced, in particular minimized and in particular avoided. Due to the fact that multiple overhead adapters are stopped simultaneously by means of the holding unit, their positioning is virtually frozen in time. The holding unit directly causes the positioning of multiple overhead adapters, wherein the held overhead adapters are arranged at a distance from each other, in particular along the conveying direction.

The holding unit is designed in particular to stop the movement of multiple overhead adapters in the conveyor rail in the conveying direction at the same time. The holding unit prevents the overhead adapters from further conveying movement and holds the overhead adapters in their current position. Overhead adapters that are not in contact with the holding unit can continue to be conveyed in the conveying direction. Holding an overhead adapter in the holding unit means stopping the movement of the overhead adapter in the conveying direction.

The holding unit is designed in such a manner that the overhead adapters are held in their arrangement in the holding unit. The arrangement of the overhead adapters in the holding unit depends in particular on the thickness of a conveyor bag that is conveyed by means of an overhead adapter. The distance between the overhead adapters along the conveying direction results from the fact that the bag thickness of the loaded bags is generally greater than the width of the overhead adapters in the conveying direction.

In particular, a conveyor bag is suspended from an overhead adapter. Each conveyor bag can be loaded with at least one item, in particular individual goods. It is advantageous if the conveyor bags are each loaded with exactly one individual item of goods. It is conceivable that unloaded conveyor bags are also arranged along the stream of goods. Unloaded conveyor bags have a bag thickness that is less than or equal to the width of the overhead adapter.

The thickness of the conveyor bag is oriented in the conveying direction. The conveying direction is determined by a conveyor rail in which the overhead adapters are movably arranged. In particular, there is no additional dynamic pressure on the overhead adapters held by the holding unit. In particular, the foremost overhead adapter, which is stopped by the stopping member, is relieved of pressure. In addition to the overhead adapters in the region of the holding unit, there are no or at most a small number of overhead adapters that exert additional dynamic pressure on the overhead adapter at the stopping member. A small number means that a maximum of five additional overhead adapters are accumulated on the overhead adapter at the stopping member, in particular a maximum of four additional overhead adapters, in particular a maximum of three additional overhead adapters, in particular a maximum of two additional overhead adapters and in particular a maximum of one additional overhead adapter.

By holding the overhead adapters, their positioning in the region of the holding unit, in particular the distance between the overhead adapters in the conveying direction, is fixed, i.e. virtually frozen in time.

The overhead adapters are conveyed in the conveyor rail in particular by means of a drive means and a drive chain, as is known in principle from DE 10 2010 010 107 A1. The conveying apparatus is also known as an accumulating conveyor. However, conveying can also take place in that the conveyor rail slopes downwards along the conveying direction, in particular linearly, i.e. a downwardly inclined conveyor rail. The conveyor rail can additionally or alternatively be curved downwards along the conveying direction. Additionally or alternatively, conveying can also be carried out using a so-called Power & Free conveyor system, i.e. a two-rail system in which a drive chain runs in the upper rail, with which overhead adapters can be driven in the rail below.

The overhead conveyor apparatus comprises a stopping member with which the overhead adapters are stopped in the conveyor rail. The stopping member is used to actively stop exactly one overhead adapter. In particular, the overhead adapter is prevented from being conveyed further by the stopping member. Subsequent overhead adapters are accumulated on the stopped overhead adapter. In particular, the stopping member is of uncomplicated design and ensures reliable and robust stopping of the movement of the overhead adapter in the conveyor rail, in particular by mechanically blocking the conveying path of the overhead adapter in the conveyor rail.

The holding unit differs from the stopping member in particular in that the holding unit is used to fix multiple overhead adapters simultaneously and directly with regard to their position along the conveyor rail. Only the overhead adapter arranged adjacent to the stopping member is held by the stopping member. All other overhead adapters accumulate on the held overhead adapter, i.e. they are stopped indirectly.

Another difference is that the overhead adapters, which are arranged to roll in the conveyor rail with a pair of support rollers, are held by the holding unit in such a manner that the overhead adapters are prevented from oscillating around the axis of rotation of the rollers. In particular, the overhead adapters are held in a region outside the conveyor rail, in particular in a mechanically clamped manner. Unintentional swiveling of the held overhead adapters is reliably prevented. In contrast, the stopping member is arranged in particular at a position vertically above the axis of rotation of the support rollers of the overhead adapter on the conveyor rail, so that the overhead adapter can be swiveled unintentionally about the axis of rotation of the support rollers in the conveyor rail, in particular in the form of dynamic pressure caused by subsequent overhead adapters. This unintentional swiveling movement is reliably prevented by the holding unit.

Due to the fact that the holding unit can be used to set the distance between multiple overhead adapters at the same time, there is no need for additional stopping members to reduce the dynamic pressure. The investment effort for multiple stopping members is avoided. A loss of storage space is prevented. Such an overhead conveyor apparatus is economically advantageous.

An overhead conveyor apparatus in which the holding unit is designed to be switchable simplifies the defined holding of the overhead adapters. The holding unit is switchable, in particular between a holding state, in which the overhead adapters are fixed with respect to their position in the conveyor rail, i.e. in particular are arranged immovably in the conveyor rail, and a release state, in which the overhead adapters are movable in the conveyor rail.

An overhead conveyor apparatus in which the holding unit has a first holding member and a second holding member, which is designed to be movable with respect to the first holding member, is of uncomplicated design and ensures the simultaneous holding of multiple overhead adapters. The holding unit has two holding members, which are each designed in particular as holding strips. It is advantageous if a first holding bar is attached to the conveyor rail in a stationary manner. The second holding bar is designed to be movable relative to the first holding bar. In particular, the second holding bar is arranged on the conveyor rail so that it can swivel about a swivel longitudinal axis. It is also conceivable that the second holding bar is displaceable in a direction transverse to the conveying direction, which corresponds in particular to the thickness direction of the overhead adapter. In particular, the second holding bar is designed to be movable relative to the conveyor rail. In particular, the holding strips are arranged opposite each other on the conveyor rail. In particular, the holding strips each extend parallel to the conveying direction, in particular parallel to each other. In particular, the holding strips are each arranged below the conveyor rail, in particular adjacent to a lower slot of the conveyor rail. In particular, the holding strips are arranged on the conveyor rail in such a manner that they are suitable for contacting overhead adapters protruding from the underside of the conveyor rail. The holding strips enable the overhead adapters to be held in a form-fit and/or force-fit manner. In particular, the overhead adapters are clamped by the two holding members with respect to their thickness direction. This allows the respective position of the overhead adapters to be preserved, i.e. fixed, in particular independently of the accumulation of further conveyor bags that are arranged upstream of the holding unit. Further conveyor bags that are arranged upstream of the holding unit do not exert any additional dynamic pressure on the overhead adapters in the holding unit. The holding strips act in particular like brake shoes, which are arranged laterally below the conveyor rail.

In particular, the overhead adapters are mechanically clamped between the holding members, i.e. held in a friction-fit manner. The holding members fulfil the function of brake shoes.

An embodiment of the holding members in which the first holding member and/or the second holding member comprise a holding material enables improved clamping of the overhead adapters by force fit.

A holding unit having at least one switchable actuating member which is coupled to the second holding member simplifies the switchable arrangement between the holding state and the release state. In particular, the second holding member can be displaced between a release position and a holding position using at least one switchable actuating member. In the holding position, the second holding member is arranged adjacent to the first holding member so that the overhead adapters arranged therebetween are reliably clamped, i.e. held. In the release position, the second holding member is arranged displaced away from the first holding member, i.e. at a distance. In the release position, the holding unit has no holding function. Overhead adapters can be conveyed along the holding unit without braking. In particular, the holding unit has several, in particular two, actuating members. This ensures that there is sufficient contact pressure for the two holding members along the longitudinal extension of the holding unit. It is possible that multiple actuating members are used to ensure sufficient contact pressure of the holding unit as a whole, in particular for large sizes and/or for actuating members with small dimensions, which in particular only allow low contact forces.

The actuating members are in particular linear actuating members, in particular pneumatic cylinders. In principle, it is conceivable to use hydraulic cylinders, electromotive and/or electromagnetic linear actuators.

An overhead conveyor apparatus in which the second holding member is held on a displacement member, which is coupled in particular directly to the at least one actuating member, has design advantages, in particular because the second holding member can be advantageously coupled to the actuating member. The displaceability of the second holding member is functionally decoupled from the coupling with the actuating member and thus simplified. In particular, the displacement member is movably attached to the conveyor rail. The holding member itself is coupled to the displacement member. This simplifies in particular the assembly and/or interchangeability of the holding member.

A holding unit, in particular the holding members, having a longitudinal extension along the conveying direction of at least 0.3 m ensures a sufficient length to hold multiple overhead adapters simultaneously. In particular, the longitudinal extension of the holding unit along the conveying direction is at least 0.5 m, in particular at least 0.75 m, in particular at least 1.0 m and in particular at most 5.0 m. It has been recognized that it is advantageous if the holding unit can hold at least five and in particular up to ten overhead adapters simultaneously.

An embodiment of the overhead conveyor apparatus in which the holding unit is arranged at a distance from the stopping member along the conveying direction utilizes the finding that it is unproblematic if a few overhead adapters are accumulated upstream of the stopping member. Due to the spaced arrangement of the holding unit relative to the stopping member along the conveying direction, multiple, in particular at most ten, in particular at most five, in particular at most three, overhead adapters can be accumulated directly by the stopping member. The holding unit, in which the overhead adapters can be held, then adjoins these accumulated overhead adapters.

An overhead conveyor apparatus in which the stopping member is designed as a bar which can be displaced transversely, in particular perpendicular to the conveying direction, and which is arranged in particular on the conveyor rail in such a manner that the bar stops the overhead adapter to be stopped in a section arranged vertically above support rollers of the overhead adapter, enables an uncomplicated and mechanically robust design of the stopping member. A bar that can be displaced transversely to the conveying direction is arranged on the conveyor rail, in particular in such a manner that it engages in a section of the conveyor rail in which the overhead adapters are conveyed. In particular, this region is arranged vertically above the support rollers of the overhead adapters. In a stop position, the bar blocks further conveying of the overhead adapter. The direction of displacement of the bar is oriented transversely, in particular vertically, to the conveying direction and in particular horizontally. It is also conceivable that the displacement direction is oriented vertically.

An overhead conveyor apparatus comprising an accumulation detection unit, in particular arranged upstream of the holding unit, for detecting an accumulation of the overhead adapters along the conveying direction enables automation of the operation of the overhead conveyor apparatus. An accumulation detection unit is used to detect the accumulation of the overhead adapters along the conveyor rail. The accumulation of the overhead adapters is based in particular on the actuation of the stopping member. In particular, the accumulation detection unit is arranged upstream of the holding unit on the conveyor rail. However, it is also conceivable that the accumulation detection unit is arranged parallel to the holding unit in relation to the conveying direction, i.e. it is arranged in the region of the holding unit.

An accumulation detection unit having at least one sensor element which serves to detect the actual conveying speed of an overhead adapter moving, in particular, along the conveying direction on the accumulation detection unit enables intelligent detection of an accumulation process. The conveying speed of a moving overhead adapter can be detected with at least one sensor element. In particular, the accumulation detection unit has a plurality of light barriers, in particular a light grid. The accumulation detection unit is designed in particular in such a manner that a stop of the overhead adapter, i.e. a reduced conveying speed, or a significant slowdown of the overhead adapter, i.e. a reduction in the conveying speed, is detected. A significant reduction in the conveying speed is present if the detected actual conveying speed is less than half of a target conveying speed. In particular, an accumulation is detected if the conveying speed is at most 30% of the target conveying speed, in particular at most 20%, in particular at most 10% and in particular at most 5%.

An overhead conveyor apparatus comprising a control unit which has a signal communication with the accumulation detection unit and with the holding unit enables direct signal transmission from the accumulation detection unit to the holding unit via a control unit. In particular, such an overhead conveyor apparatus enables fully automatic operation.

An overhead conveyor facility comprising at least one overhead conveyor apparatus described above has the advantages of the overhead conveyor apparatus, reference to which is hereby made. The overhead conveyor facility comprises at least one and in particular a plurality of overhead conveyor apparatus. The overhead conveyor facility further comprises a store for the goods, in particular at least one loading station at which the goods are loaded, in particular singly, into a respective conveyor bag, in particular at least one sorter in which the conveyor bags are sorted, i.e. their sequence is changed with respect to the stream of goods along the conveying direction, at least one unloading station, at which the individual goods are removed from the conveyor bags, at least one packing place, at which the removed goods are packed into a shipping container and/or at least one outgoing goods zone, at which the packed shipping containers are transferred to the goods transport, in particular by means of a transport vehicle.

A method comprising the method steps of overhead conveying of goods in conveyor bags by means of overhead adapters in a conveyor rail defining a conveying direction, stopping the overhead adapters in the conveyor rail by means of a stopping member arranged on the conveyor rail and holding overhead adapters arranged upstream of the stopping member by means of the holding unit has the advantages of the overhead conveyor apparatus, reference to which is hereby made. Goods are conveyed, in particular singly, in conveyor bags by means of the overhead adapters in a suspended manner along a conveying direction of a conveyor rail. When the overhead adapters are stopped in the conveyor rail by means of an actuating member, they are accumulated. The overhead adapters, which are arranged in the region of the holding unit, are held in position by means of a holding unit.

It is advantageous if the accumulation of the overhead adapter is detected by means of an accumulation detection unit.

A method in which holding is performed in a controlled manner, in particular by means of a control unit, wherein in particular detecting an accumulation of the overhead adapters is carried out by means of an accumulation detection unit and in particular control is performed in dependence on the accumulation of the overhead adapters, is advantageous because the holding unit can be switched directly between the holding state and the release state.

Both the features specified in the patent claims and the features specified in the following exemplary embodiment of an overhead conveyor apparatus are each suitable, either on their own or in combination with one another, for further embodiment of the subject-matter. The respective combinations of features do not represent any restrictions with regard to further embodiments of the subject-matter, but are merely exemplary in character.

Further features, advantages and details of the disclosure are apparent from the following description of an exemplary embodiment with reference to the drawing.

### BRIEF DESCRIPTION OF THE DRAWINGS

FIG. 1 shows a perspective view from above of the overhead conveyor apparatus with conveyor bags conveyed on overhead adapters,

FIG. 2 shows a side view of the overhead conveyor apparatus according to FIG. 1,

FIG. 3 shows a sectional view according to section line III-III in FIG. 2,

FIG. 4 shows a partially sectioned side view of a conveyor rail of the overhead conveyor apparatus according to FIG. 1 with overhead adapters.

### DETAILED DESCRIPTION

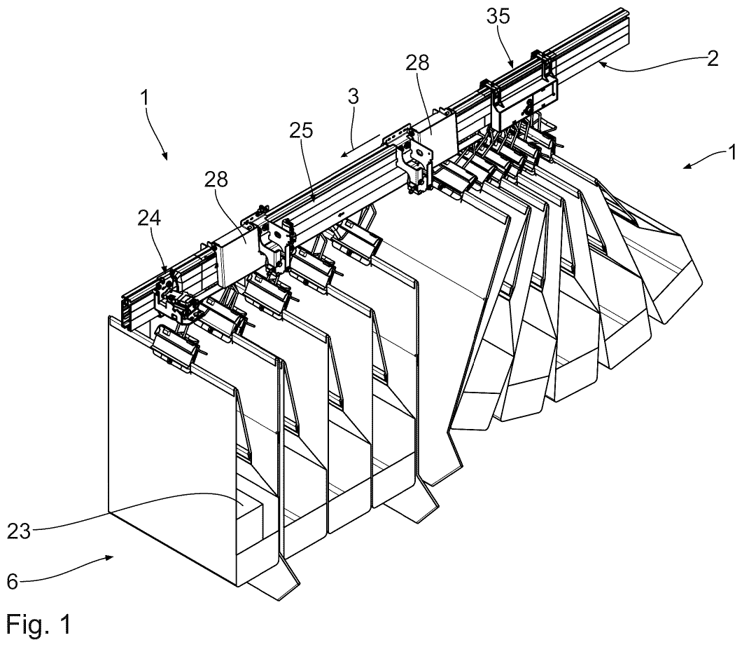

An overhead conveyor apparatus designated in total as 1 in FIGS. 1 to 4 is part of an overhead conveyor facility, not shown in detail, which is used for retrieving and/or commissioning goods from a warehouse to form orders for dispatch.

The overhead conveyor apparatus 1 comprises a conveyor rail 2, which defines a conveying direction 3. According to the exemplary embodiment shown, the conveyor rail 2 and thus also the conveying direction 3 runs linearly, in particular horizontally. It is understood that the conveyor rail 2 can also extend upwards or downwards at least in sections, in an inclined and/or curved manner relative to the horizontal.

The conveyor rail 2 is designed as a hollow box profile in which a drive chain 4 is arranged and can be driven in the conveying direction 3 by means of a drive means not shown, in particular an electric motor. Holding means 5 are movably arranged in the conveyor rail 2 by means of the drive chain 4. The holding means 5 serve to detachably couple the conveying container, in particular a flexible conveyor bag 6. In each case, a conveyor bag 6 can be conveyed in a suspended manner for transporting goods on the holding member 5 along the conveying direction 3. The holding members 5 are overhead adapters.

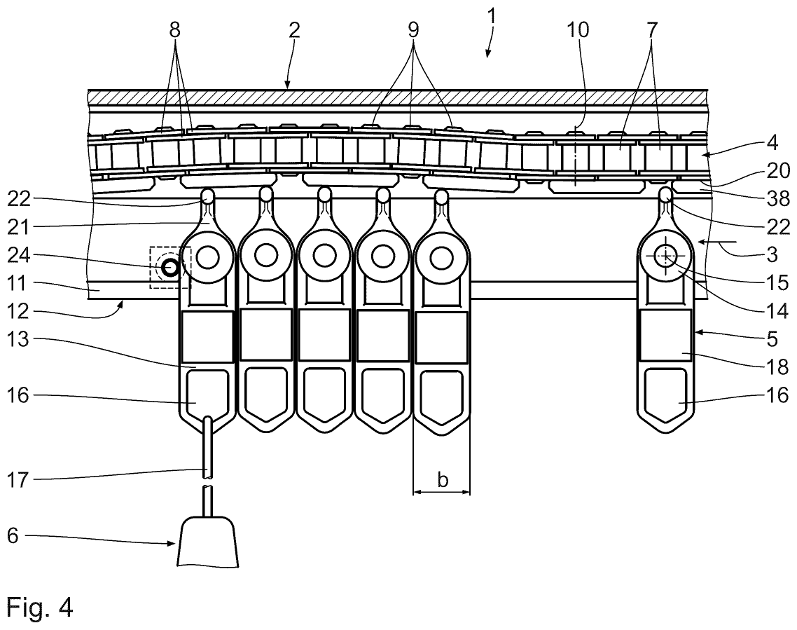

The drive chain 4 is a so-called roller chain, which has rollers 7 that are connected to one another at a short distance from each other by means of connection lugs 8 and rivets 9. The drive chain 4 has joints that can be swiveled around vertical axes 10. The rivets 9 have bores that are not shown in detail. In particular, the rivets 9 are hollow rivets. The joints of the drive chain 4 are designed with normal play, which also means that the chain links can run in an arc, as shown by the partially curved course of the drive chain 4 in FIG. 4.

The drive chain 4 is guided and held in the conveyor rail 2 in the direction of the rivets 9, i.e. vertically and transversely to the conveying direction 3 by means of the connection lugs 8.

Two guiding webs 11 are formed on the underside of the conveyor rail 2, which are directed towards each other and between which a slot 12 extending in the longitudinal direction of the conveyor rail 2, i.e. in the conveying direction 3, is formed or bounded. A flat supporting part 13 of each overhead adapter 5 projects downwards out of the conveyor rail 2 through this slot 12. In its upper region, the overhead adapter 5 has a caster 14 on either side of the supporting part 13, which is also referred to as a support roller. The casters 14 are each supported on one of the two guiding webs 11 and can be moved, in particular rolled, in the conveying direction 3. There is therefore only one pair of casters 14, which are rotatable about a common axis 15, so that the entire overhead adapter 5 can oscillate about the axis 15 in the conveyor rail 2. By oscillating about the axis 15, the overhead adapter 5 is inclined relative to the conveyor rail 2, i.e. relative to a normal to the conveyor rail 2 in a vertical plane defined by the conveying direction 3.

The supporting part 13 has a receiving opening 16 at its lower end, into which a hook 17 of the conveyor bag 6 can be hooked. An identification member 18, which may be a transponder, a barcode or a QR code, is arranged between the receiving opening 16 and the underside of the conveyor rail 2. The identification member 18 extends in accordance with the arrangement of the plate-like supporting part 13 in the conveying direction 3, i.e. its main surface is open transversely to the conveying direction 3, i.e. towards the side. It can thus be clearly detected by means of an identification device, as it does not overlap with other identification members 18.

A conveyor bag 6 with an item to be transported remains attached to the overhead adapter 5 during the entire conveying process after it has been hooked into the overhead adapter 5, i.e. it is “married” to same, so to speak. The item to be transported is therefore controlled, on the one hand, via the identification member 18 and thus via the overhead adapter 5. Since the entire conveying process is carried out from the drive chain 4, it is important that the overhead adapter 5 assumes an absolutely unique position relative to the drive chain 4 during conveying.

Above the support rollers 14, the overhead adapter 5 has a stalk-like projection 21, which is formed in one piece with the supporting part 13. At the upper end of this stalk-like projection 21, a stop 22 is formed in the manner of a crossbar. The stop 22 forms a lower coupling part for mechanical coupling with the drive chain 4.

On the underside 20 of the drive chain 4, on each chain link an upper coupling part 38 is arranged, which is made of plastic in particular. The upper coupling part 38 is formed with two pins, not shown in detail, which are received in the bores of the hollow rivets 9. In particular, the end faces of the pins are designed with flattened, slotted and splayed ends and form a snap lock with which the upper coupling parts 38 are firmly secured to the drive chain 4, in particular mechanically latched. The snap locks allow uncomplicated assembly of the upper coupling parts 38 on the drive chain 4, in particular without tools.

A specific embodiment and the operating principle of the accumulating conveyor 1, in particular of the coupling parts 22, 38, is described in DE 10 2010 010 107 A1, reference to which is hereby expressly made.

The structure and function of the conveyor bags 6 are explained in detail in DE 10 2018 201 675 A1, reference to which is hereby expressly made.

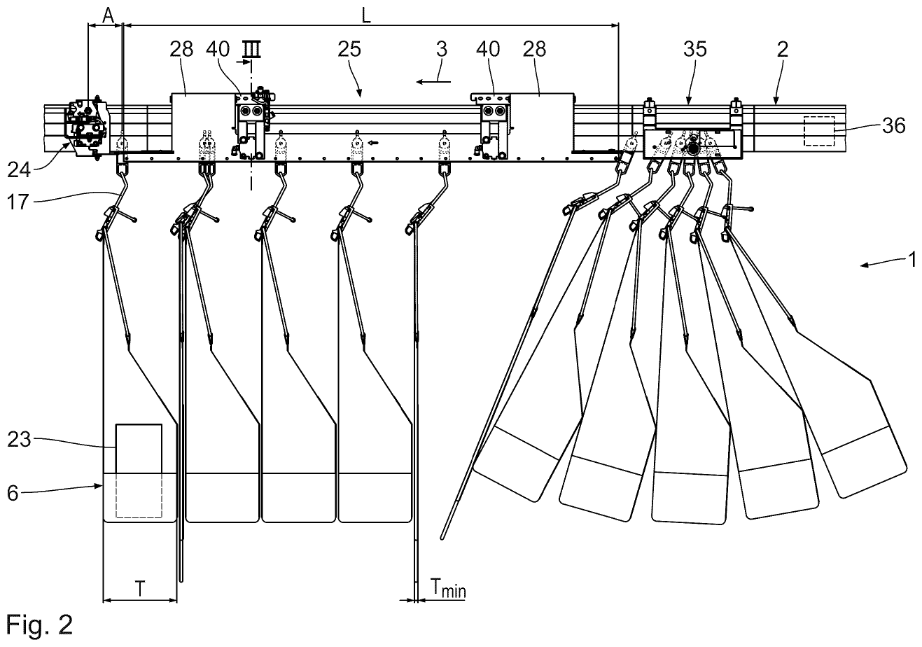

The conveyor bags 6 can be loaded with goods 23 to be transported, which are shown purely schematically in FIG. 2. The conveyor bag 6 is designed to be flexible in such a manner that the outer dimension of the conveyor bag 6 results from the size of the goods 23. Since the dimensions of the goods 23 to be transported differ, the respective bag width T, which extends along the conveying direction 3, is also different for the various conveyor bags 6. For purely illustrative reasons, the pocket widths T for the loaded conveyor bags 6 are shown identically. Empty, i.e. unloaded, conveyor bags 6 are also shown in FIG. 2, which have a minimum bag width Tₘᵢₙ.

The overhead conveyor apparatus 1 comprises a stopping device with a stopping member 24, which is arranged on the conveyor rail 2 and, in particular, is fastened thereto. The stopping member 24 is designed in particular to be switchable, in particular as a bar that can be displaced transversely to the conveying direction 3. The bar is in particular bolt-shaped, but can also have other geometries, in particular other outer contours. It is advantageous if the bar is rod-like or bar-shaped. The bar can be displaced between a passage arrangement and a stop arrangement. In the passage arrangement, the bar is arranged at a distance from the overhead adapters 5. In the stop arrangement, the bar projects into the hollow box profile of the conveyor rail 2, in particular in a region above the guiding webs 11 and in particular in a region of the support rollers 14. The bar extends in particular in a plane perpendicular to the conveying direction 3 and in particular perpendicular to a vertical plane comprising the slot 12.

Upstream of the stopping member 24 with respect to the conveying direction 3, the overhead conveyor apparatus 1 has a holding unit 25. The holding unit 25 is arranged along the conveying direction 3 at a distance from the stopping member 24 on the conveyor rail 2, in particular at a distance A. The distance A is in particular a multiple of the width b of the overhead adapter 5, wherein the multiple is greater than 1. This means that a plurality of overhead adapters 5 can be arranged along the conveying direction 3 between the stopping member 24 and the holding unit 25.

The holding unit 25 has two holding members 26, 27, which are designed as holding strips according to the exemplary embodiment shown. The first holding member 26 is attached directly to the conveyor rail 2. The first holding member 26 is arranged in a fixed position relative to the conveyor rail 2. The second holding member 27 is held on a frame-like sheet metal blank, which forms a displacement member 28. The displacement member 28 is arranged to swivel about a swivel axis 29 with respect to the conveyor rail 2. The swivel axis 29 extends parallel to the conveying direction 3. The swivel axis 29 is defined by a screw connection, by means of which the displacement member 28 can be connected to a holding plate 40. The holding plate 40 is attached to an upper side of the conveyor rail 2. The swivel axis 29 extends in particular above the conveyor rail 2 and in particular laterally in a vertical continuation of a side wall of the hollow box profile of the conveyor rail 2.

In particular, the holding unit 25 comprises two displacement members 28 in each case. At least one displacement member 28 should be provided.

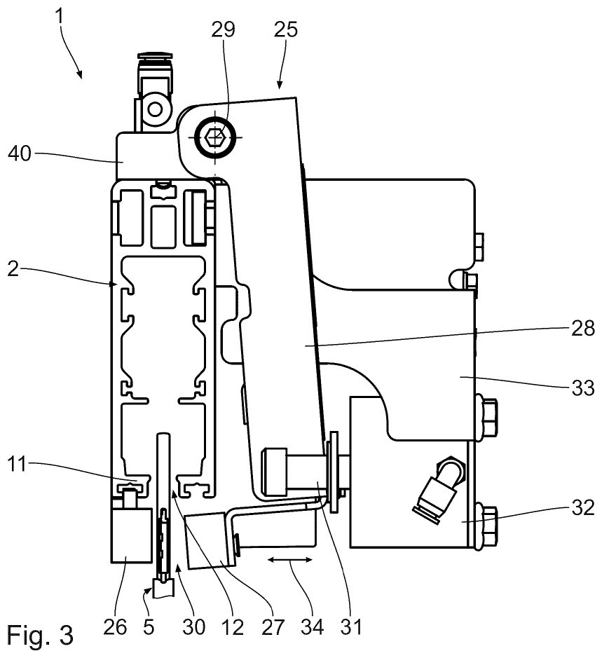

The second holding member 27 is directly attached to the displacement member 28. A displacement of the displacement member 28 directly causes a displacement of the second holding member 27. The second holding member 27 can be displaced between a release position shown in FIG. 3, in which the second holding member 27 is arranged at a distance from the overhead adapters 5, and a holding position, in particular swiveled about the swivel axis 29. In the holding position, the second holding member 27 rests directly against the overhead adapter 5, in particular its supporting part 13, and presses it against the oppositely arranged first holding member 26. The holding members 26, 27 are each arranged below the conveyor rail 2, in particular adjacent to the slot 12. In the release position of the second holding member 27, a release slot 30 is formed between the holding members 26, 27, which is arranged in alignment with the slot 12 and extends along the conveying direction 3. The supporting part 13 of the overhead adapter 5 is guided through the release slot 30. In the release position, the overhead adapters 5 can be conveyed along the holding unit 25 without contact.

An actuating member 31 is mechanically coupled directly to the displacement member 28. In particular, the actuating member 31 is a linearly displaceable lifting cylinder, which can be actuated pneumatically in particular by means of an actuating drive 32. By means of the actuating member 31, the displacement member 28 and thus the second holding member 27 is configured to be switchable. The holding unit 25 can be switched as a whole, namely between the release state shown in FIG. 3, in which the second holding member 27 is in the release position, and a holding state, in which the second holding member 27 is in the holding position. The actuating member 31 and the actuating drive 32 are held on the conveyor rail 2 by means of a separate mount 33. In particular, the mount 33 is independent of the displacement member 28. The mount 33 is stationary.

The displacement direction 34 of the actuating member 31 extends transversely and in particular perpendicular to the conveying direction 3, in particular perpendicular to a vertical plane containing the conveying direction 3.

The holding members 26, 27 each have a holding material which improves holding of the overhead adapters 5, in particular force-fit clamping of the overhead adapters 5. In particular, a plastic strip, in particular a rubber strip, serves as the holding material.

Alternatively, the first holding member 26 and in particular the second holding member 27 can be designed with multiple movable pins, in particular spring-loaded pins, arranged next to one another along the conveying direction 3, which are movable along the displacement direction 34 of the actuating drive 32. The pins can engage in a space between two adjacent overhead adapters 5. If the pins are arranged in the region of an overhead adapter 5, they come to rest against the overhead adapter 5 and, in particular, do not lead to clamping of the overhead adapter 5 itself. The overhead adapter 5 is held in place in particular by the pins engaging in the spaces between the overhead adapters 5. In this case, it is particularly sufficient if the holding unit 25 has only a single holding member, namely the second holding member 27. In this case, the first holding member 26 is dispensable.

The holding unit 25 has a longitudinal extension L, which is approximately 1.0 m according to the exemplary embodiment shown. The longitudinal extension L is oriented along the conveying direction 3. The longitudinal extension L results in particular from the longitudinal extension of the holding members 26, 27.

The overhead conveyor apparatus 1 comprises an accumulation detection unit 35, which is arranged upstream of the holding unit 25 on the conveyor rail 2 according to the exemplary embodiment shown. The accumulation detection unit 35 serves to detect an accumulation of the overhead adapters 5 along the conveyor rail 2. The accumulation detection unit 35 comprises at least one sensor element not shown in more detail, in particular multiple sensor elements. In particular, the accumulation detection unit 35 is designed as a light grid. In particular, the accumulation detection unit 35 is designed in such a manner that the actual conveying speed at which the overhead adapters 5 are conveyed along the conveyor rail 2 can be detected.

The overhead conveyor apparatus 1 comprises a control unit 36, which is shown purely schematically in FIG. 2. The control unit 36 has a signal communication with the accumulation detection unit 35 and with the holding unit 25 and, in particular, with the stopping member 24. The signal communication can be wireless or wired. The control unit 36 can be integrated into a higher-level system control of the overhead conveyor facility.

A method for conveying goods using the overhead conveyor apparatus 1 is explained in more detail below.

The conveyor bags 6, which are at least partially loaded with one item 23 each, are conveyed in the conveyor rail 2 along the conveying direction 3. Conveying takes place by means of a drive means, wherein in particular the drive chain 4 can be designed in accordance with DE 10 2010 010 107 A1. Such an overhead conveyor apparatus 1 is also referred to as an accumulating conveyor. The drive chain 4 enables the overhead adapters 5 to be conveyed. If the overhead adapters 5 are blocked, in particular if the overhead adapters 5 are stopped in a targeted manner, the drive chain 4 can be mechanically decoupled from the overhead adapters 5, in particular the stops 22.

When the stopping member 24 is activated in the overhead conveyor apparatus 1, the bar is displaced to the stop position. As a result, the overhead adapters 5 are stopped by the stopping member 24 and prevented from being conveyed further along the conveying direction 3.

By actuating the stopping member 24, the overhead adapter 5 directly resting against the stopping member 24 is stopped. The subsequent overhead adapters 5 with the conveyor bags 6 mounted thereto come to rest against the conveyor bag 6 arranged upstream in each case or the overhead adapter 5 arranged upstream in each case. The subsequent overhead adapters 5 with conveyor bags 6 are accumulated by the overhead adapter 5 with the conveyor bag 6 arranged upstream in each case. As a result of the increasing dynamic pressure, the overhead adapters 5 can run onto each other and the conveyor bags 6 are swiveled upwards about the axis 15, around which the overhead adapters 5 are arranged in the conveyor rail 2 in an oscillating manner, in a clockwise direction according to FIG. 2.

The holding unit 25 is in the release state at this point. This means that the overhead adapters 5 with the conveyor bags 6 hooked to them can be conveyed along the conveying direction 3 by the holding unit 25. The subsequent overhead adapters 5 form an accumulated arrangement, as shown in FIG. 2 or 4.

If the accumulation detection unit 35 recognizes an accumulation of the overhead adapters 5, in particular because the actual conveying speed of the overhead adapters 5 in the region of the accumulation detection unit 35 deviates significantly from a target conveying speed, the accumulation detection unit 35 outputs a detection signal which is transmitted to the control unit 36. The control unit 36 transmits a corresponding control signal to the actuating drive 32, which exerts a drive movement on the actuating member 31 along the displacement direction 34, so that the displacement member with the second holding member 27 held thereon is displaced from the release position to the holding position. As a result, all overhead adapters 5 that are arranged in the region of the holding unit 25 are held in their position, i.e. in particular with overhead adapters 5 arranged at a distance from one another.

By means of the overhead conveyor apparatus 1, in particular by means of the holding unit 25, it is possible to preserve the respective position of the overhead adapters 5 with the conveyor bags 6 hanging therefrom, in particular at a time when no or at most only slight dynamic pressure is acting on this conveyor bag 6. This avoids or reduces the risk of unintentional deflection of the conveyor bags 6 and/or unintentional application of force to the individual overhead adapters 5 due to subsequent overhead adapters 5.

When the holding unit 25 is in the holding state, conveying of overhead adapters 5 along the conveying direction 3 into the holding unit 25 is prevented. The upstream end of the holding unit 25, which is arranged facing away from the stopping member 24, serves as the stopping member 24 for stopping the overhead adapters 5 before they enter the holding unit 25. It is also possible to arrange a separate stopping member 24 in this region in order to protect the holding unit 25 and in particular the holding members 26, 27 from mechanical impairment.

The accumulation detection unit 35 can also be arranged at a different position on the overhead conveyor apparatus 1 along the conveying direction 3, in particular in the region of the holding unit 25, i.e. along the longitudinal extension L. It is also possible to design the accumulation detection unit 35 with sensors which, for example, detect the dynamic pressure on the overhead adapters 5 in the region of the stopping member 24, in particular as force measurement sensors. Additionally or alternatively, the accumulation detection unit 35 can also have optical sensors that detect the filling state of the holding unit 25 with overhead adapters 5.

When the stopping member 24 is displaced back to the passage position and thus conveying of the conveyor bags 6 is continued, the holding unit 25 is also opened, i.e. switched to the release state, thus enabling further conveying of the overhead adapters 5 in the region of the holding unit 25.

What is claimed is:

1. An overhead conveyor apparatus comprising:
a conveyor rail defining a conveying direction;
a plurality of overhead adapters movable via the conveyor rail in the conveying direction;
a stopping member arranged on the conveyor rail for stopping at least one overhead adapter of the plurality of overhead adapters; and
a holding unit arranged upstream of the stopping member for holding at least one overhead adapter of the plurality of overhead adapters.

2. The overhead conveyor apparatus according to claim 1, wherein the holding unit is switchable.

3. The overhead conveyor apparatus according to claim 1, wherein the holding unit has a first holding member and a second holding member movable with respect to the first holding member.

4. The overhead conveyor apparatus according to claim 3, wherein the first holding member and/or the second holding member includes a holding material.

5. The overhead conveyor apparatus according to claim 3, wherein the holding unit has at least one switchable actuating member coupled to the second holding member.

6. The overhead conveyor apparatus according to claim 3, wherein the second holding member is coupled to a displacement member.

7. The overhead conveyor apparatus according to claim 6, wherein the displacement member is coupled directly to at least one switchable actuating member.

8. The overhead conveyor apparatus according to claim 1, wherein the holding unit includes a longitudinal extension along the conveying direction of at least 0.3 m in length.

9. The overhead conveyor apparatus according to claim 1, wherein the first and second holding members each have a longitudinal extension along the conveying direction of at least 0.3 m in length.

10. The overhead conveyor apparatus according to claim 1, wherein the holding unit is positioned at a distance from the stopping member along the conveying direction.

11. The overhead conveyor apparatus according to claim 1, wherein the stopping member is formed as a bar that is displaceable transversely.

12. The overhead conveyor apparatus according to claim 11, wherein the stopping member is formed as a bar that is displaceable perpendicular to the conveying direction.

13. The overhead conveyor apparatus according to claim 1, further including an accumulation detection unit for detecting an accumulation of overhead adapters of the plurality of overhead adapters along the conveying direction.

14. The overhead conveyor apparatus according to claim 13, wherein the accumulation detection unit is positioned upstream of the holding unit along the conveying direction.

15. The overhead conveyor apparatus according to claim 13, wherein the accumulation detection unit includes at least one sensor element configured to detect the conveying speed of an overhead adapter of the plurality of overhead adapters.

16. The overhead conveyor apparatus according to claim 13, including a control unit configured for signal communication with the accumulation detection unit and with the holding unit.

17. An overhead conveyor facility including the overhead conveyor apparatus according to claim 1.

18. A method comprising:
conveying goods in conveyor bags using overhead adapters via a conveyor rail defining a conveying direction;
stopping the overhead adapters via a stopping member arranged on the conveyor rail; and
holding the overhead adapters upstream of the stopping member via a holding unit.

19. The method according to claim 18, further including detecting an accumulation of the overhead adapters with an accumulation detection unit.

20. The method according to claim 19, wherein a control unit is configured to control the holding based at least in part on an accumulation of the overhead adapters.
